(19) United States
(12) Patent Application Publication
(10) Pub. No.: US 2021/0285409 A1
(43) Pub. Date: Sep. 16, 2021

(54) Fuel Pump

(71) Applicant: CPT Group GmbH, Hannover (DE)

(72) Inventors: Dirk BECKER, Alheim (DE); Michael BÄMPFER, Rotenburg (DE); Jens MISSUN, Baunatal (DE); Marc VÖLKER, Magdeburg (DE)

(21) Appl. No.: 16/343,302

(22) PCT Filed: Oct. 5, 2017
(86) PCT No.: PCT/EP2017/075278

§ 371 Date: Apr. 18, 2019

(30) Foreign Application Priority Data
Oct. 20, 2016 (DE) 10 2016 220 638.9

(51) Int. Cl. F02M 37/10; H02K 5/22; F02M 37/00; H02K 5/132

(52) U.S. Cl. CPC F02M 37/10; H02K 5/132; F02M 37/0011; H02K 5/225

(57) ABSTRACT

A fuel pump includes an electric motor, a pump stage and a motor housing with a plastic section that holds a stator of the electric motor. The plastic section has a rim on the side facing the pump housing, when seen from the stator. A sheet metal sheath engages behind a rim of the motor housing and a rim of the pump housing by rolled portions so as to permit the fuel pump to be produced cost-effectively.

### CROSS REFERENCE TO RELATED APPLICATIONS

This is a U.S. national stage of application No. PCT/EP2017/075278, filed on Oct. 5, 2017, which claims priority to German Application No. 10 2016 220 638.9, filed Oct. 20, 2016, the content of each of which is incorporated herein by reference.

### BACKGROUND OF THE INVENTION

### 1. Field of the Invention

The invention relates to a fuel pump having an electric motor and having a pump stage.

### 2. Description of the Prior Art

Such fuel pumps are frequently used in modern motor vehicles and are known from practice. In the case of the known fuel pump, the electric motor and the pump stage are rolled together with a sheet-metal casing such that both the electric motor and the pump stage are encapsulated and at the same time sealingly enclosed. A pressure-side interface to the electric motor, on the one hand, and a suction-side arrangement of an axially acting seal or axial seal, on the other hand, influence a bracing of the pump stage that occurs during the rolling of the sheet-metal casing. Here, this bracing extends over the entire pump stage and leads to a statically overdeterminate or indeterminate installation situation of the pump stage.

The pump stage of the fuel pump may be in the form of a peripheral pump, a side-channel pump or a screw pump.

A disadvantage in the case of the known fuel pump is, however, that the sheet-metal casing constitutes a very expensive component. Furthermore, the sheet-metal casing closes the radial circumference of the electric motor and of the pump stage, such that all connections are led away from the fuel pump axially. The known fuel pump therefore has particularly large axial dimensions. Large axial dimensions are, however, very disruptive if the fuel pump is to be arranged within a fuel tank.

### SUMMARY OF THE INVENTION

It is an object of the invention to solve the problem of further developing a fuel pump having a motor housing of the electric motor, having a pump housing of the pump stage, and having a sheet-metal casing which engages behind edges of the motor housing and of the pump housing, wherein the motor housing is designed to hold a stator, which surrounds a rotor, of the electric motor such that it is particularly inexpensive to manufacture and has particularly small dimensions.

This problem may be solved according to one aspect of the invention in that the motor housing has a portion made of plastic that holds the stator, and in that, as viewed from the stator, the edge of the motor housing for the sheet-metal casing is arranged on the side facing toward the pump housing.

By this configuration, the sheet-metal casing extends only from that edge of the motor housing that faces toward the pump housing as far as over the pump housing. By virtue of the invention, the predominant region of the electric motor is not surrounded by the sheet-metal casing. The sheet-metal casing can thus be made to be particularly short. The fuel pump according to an aspect of the invention can therefore be manufactured particularly inexpensively. Furthermore, connectors can be led away radially from a portion of the electric motor made of plastic. This is conducive to particularly small dimensions of the fuel pump.

According to another advantageous refinement of the invention, the fuel pump can be manufactured particularly inexpensively if the height of the sheet-metal casing amounts to at most 50% of the sum of the heights of the pump housing and of the motor housing.

In the case of known fuel pumps, connection contacts of the stator are generally flowed around by fuel. To prevent corrosion, very expensive seals and coatings of the connection contacts are known. According to another advantageous refinement of the invention, expensive seals of connection contacts of the electric motor can be easily avoided if connection contacts of the stator are sealingly enclosed by the plastic of the motor housing. The plastic portion of the motor housing is preferably manufactured in a particularly inexpensive manner in an injection molding process.

According to another advantageous refinement of the invention, it is conducive to a reduction of the axial structural height of the fuel pump if connection lines leading to the electric motor are led radially into the plastic portion of the motor housing.

According to another advantageous refinement of the invention, the number of components of the fuel pump can be kept particularly low if the plastic portion of the motor housing has a connector piece for a fuel line. By this configuration, a cover, which must be separately mounted, for the connector piece is avoided.

Furthermore, connectors can be led away radially from the plastic portion of the electric motor. This is conducive to particularly small dimensions of the fuel pump. By this configuration, the fuel pump can be arranged even in fuel tanks of low height.

It is conducive to a further reduction of the axial dimensions of the fuel pump if the connector piece is arranged at the axial height of the stator.

According to another advantageous refinement of the invention, channels for conducting fuel through the fuel pump can be manufactured particularly easily if a cover, which leads to the connector piece, of a channel is sealed off on the plastic portion of the motor housing. The sealing is realized preferably in a welding process, for example by mirror welding, or by adhesive bonding.

According to another advantageous refinement of the invention, the plastic portion of the motor housing can be manufactured in a particularly simple tool mold if a portion of the fuel-conducting channel is led, parallel to the axis of the rotor, from the end averted from the pump housing into the motor housing.

According to another advantageous refinement of the invention, a bearing arrangement, which must be separately installed, of the rotor of the electric motor can be avoided if the rotor of the electric motor is mounted with one end on the pump housing and with the other end in the plastic portion of the motor housing.

According to another advantageous refinement of the invention, the assembly of the fuel pump is made particularly simple if that portion of the motor housing that holds the stator has an open side, facing toward the pump housing, for the insertion of the rotor. By this configuration, the electric motor can be installed from one side, specifically the side facing toward the pump stage.

According to another advantageous refinement of the invention, the fuel pump is of particularly simple structural design if the portion made of plastic has support arms for supporting the bearing arrangement of the rotor, and a channel for conducting the fuel leads through between the support arms.

According to another advantageous refinement of the invention, the seal of the fuel pump is of particularly simple structural design if a sealing ring with radial sealing action is arranged between the pump housing and the sheet-metal casing. The sealing ring may be formed as an elastomer O-ring. Alternatively, the sealing ring may also be formed as a round cord ring. Such round cord rings are manufactured as a cord in an extrusion process and connected together in butt-jointed fashion by adhesive bonding or vulcanization.

### BRIEF DESCRIPTION OF THE DRAWINGS

The invention permits numerous embodiments. To further illustrate its basic principle, several of these embodiments are illustrated in the drawing and will be described below. In the drawings:

FIG. 1 shows a fuel delivery unit installed in a fuel tank;

FIG. 2 shows a longitudinal section through a fuel pump of the fuel delivery unit from FIG. 1;

FIG. 3 shows a plan view of the fuel pump from FIG. 2;

FIG. 4 shows a fuel delivery unit installed in a fuel tank;

FIG. 5 shows a longitudinal section through a fuel pump of the fuel delivery unit;

FIG. 6 shows a longitudinal section through the fuel pump;

FIG. 7 shows a side view of the fuel pump from FIG. 6; and

FIG. 8 shows a plan view of the fuel pump from FIG. 6.

### DETAILED DESCRIPTION OF THE PRESENTLY PREFERRED EMBODIMENTS

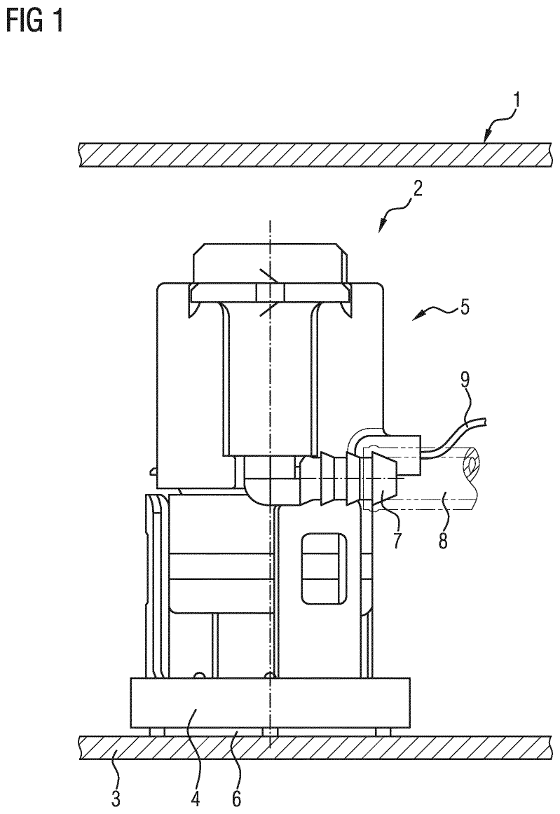

FIG. 1 shows a subregion of a fuel tank 1, illustrated in section, with a fuel delivery unit arranged therein. The fuel delivery unit 2 has a holder 4, which is preloaded against the base 3 of the fuel tank 1, for a fuel pump 5 with a prefilter 6. A connector piece 7 for connection to a fuel-discharging fuel line 8 is led radially away from the fuel pump 5. Electrical connection lines 9 for the supply of electrical current to the fuel pump 5 are likewise led radially away from the fuel pump 5. The connector piece 7 and the connection lines 9 are arranged in an axial central region of the fuel pump 5.

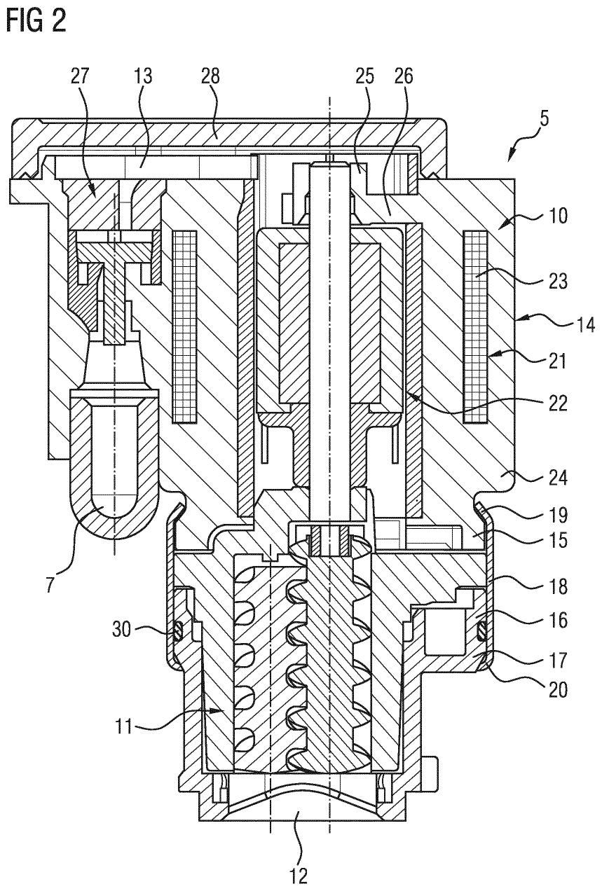

FIG. 2 shows a longitudinal section through the fuel pump 5 from FIG. 1. It can be seen here that an electric motor 10 drives a pump stage 11. The pump stage 11 draws fuel in via an intake connector 12 and delivers this fuel through the electric motor 10 via a channel 13 to the connector piece 7. The electric motor 10 has a manufactured motor housing 14 with an edge 15 facing toward the pump stage 11. The pump stage 11 has a pump housing 16 with, likewise, an edge 17. A sheet-metal casing 18 engages behind the edges with, in each case, one rolled portion 19, 20 and thus preloads the pump housing 16 against the motor housing 14.

The electric motor 10 has a stator 21 and a rotor 22 connected to the pump stage 11. Coils 23 or permanent magnets of the stator 11 are arranged within, and encapsulated by, a portion 24 of the motor-housing that is made of plastic. The rotor 22 is mounted in the pump stage 11 and has a further bearing arrangement 25 in the end, averted from the pump stage 11, of the plastic portion 24 of the motor housing 14, The bearing arrangement 25 is held by multiple support arms 26 of the motor housing 14. Between the support arms 26, the fuel flows from the pump stage 11 to the connector piece 7.

In the channel 13 provided for conducting fuel, there is arranged a check valve 27. The channel 13 is closed off, at a portion 24 arranged in that side of the motor housing 14 which is averted from the pump stage 11, by a cover 28. The cover 28 is sealingly connected to the plastic portion 24 of the motor housing 14. The sealing connection is produced, for example, in a welding process or by adhesive bonding. A sealing ring 30, formed, for example, as an O-ring or as a round cord ring, seals off the pump housing 16 radially with respect to the sheet-metal casing 18.

By the radial seal of the pump housing 16 with respect to the sheet-metal casing 18, a floating centering of the pump stage is realized. Furthermore, the rolled region of the sheet-metal casing 18 on the pump stage 16 can be displaced toward the pressure side of the pump stage 16, such that the length of the sheet-metal casing 18 can be further reduced.

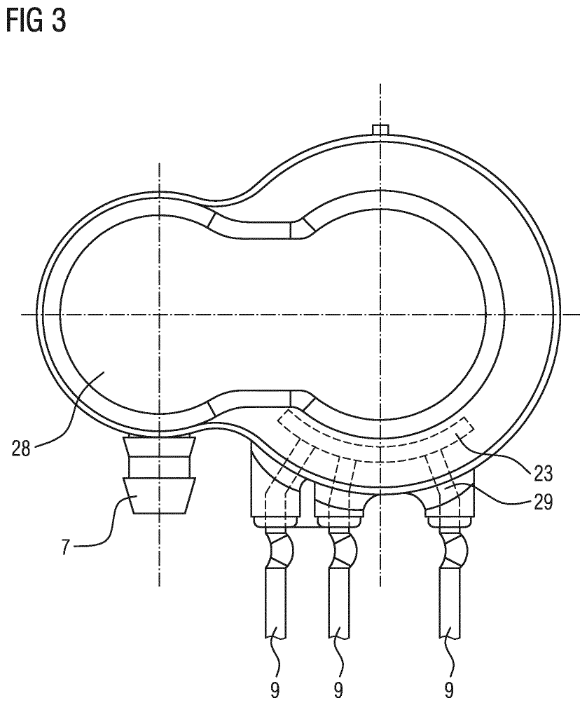

FIG. 3 shows the fuel pump 5 in a plan view directed toward the cover 28. It can be seen in this view that the connection lines 9 are led into the plastic portion 24 of the motor housing 14 , and are partially encapsulated by this plastic portion. Likewise, connection contacts 29, which produce a conductive connection of the fuel pump 5 to the connection lines 9 are encapsulated by the plastic of the plastic portion 24 of the motor housing 14.

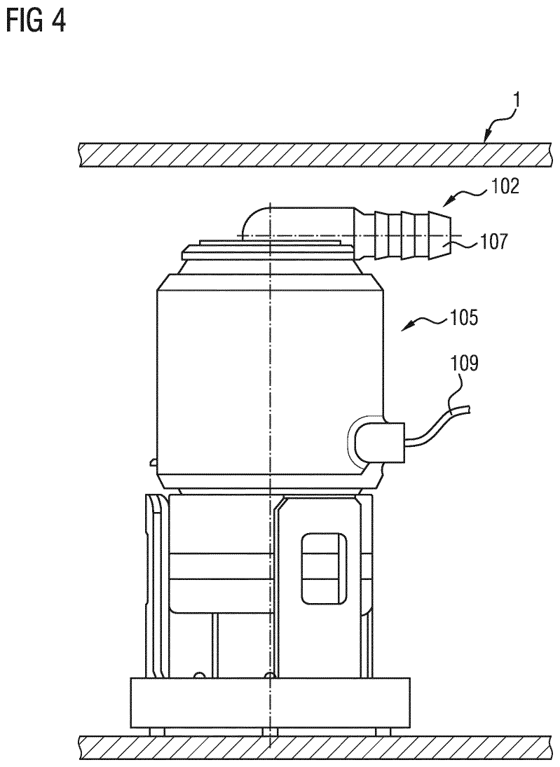

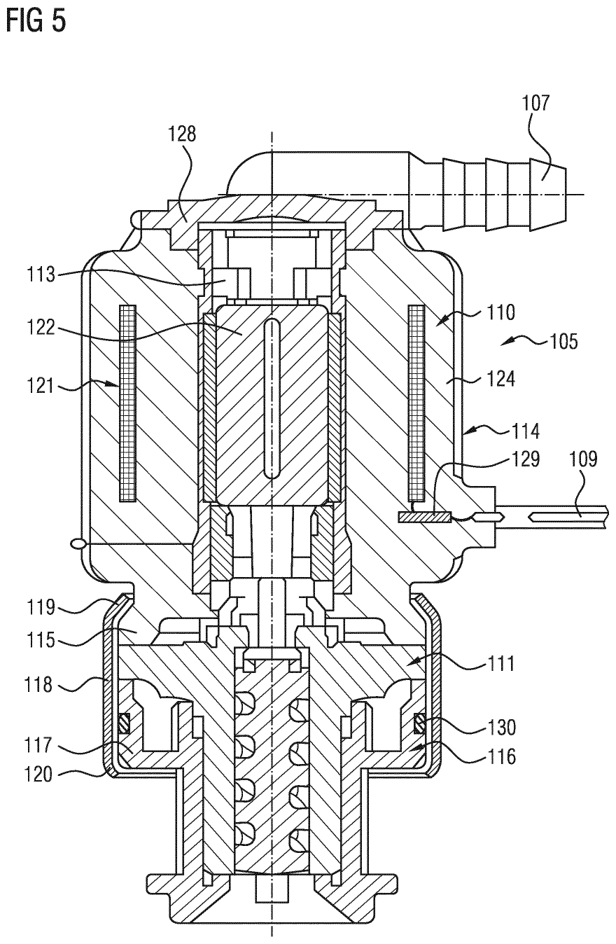

FIG. 4 shows a further embodiment of a fuel delivery unit 102 with a fuel pump 105. FIG. 5 shows the fuel pump 105 in a longitudinal section. This fuel pump differs from that in FIGS. 1 to 3 in that a fuel-conducting channel 113 is led away through an end side, averted from a pump stage 11, of an electric motor 110. A cover 128 that closes off the end side bears a connector piece 107 for a fuel line and is sealed off with respect to a portion 124, made of plastic, of the motor housing 114. Connection lines 109 leading to the electric motor 110 lead radially into a portion 104, made of plastic, of the motor housing 114. Connection contacts 129 of the fuel pump 105 are encapsulated by the plastic. The pump housing 116 is supported radially relative to a sheet-metal casing 118 by a sealing ring 130. By rolled portions 119, 120, the sheet-metal casing 118 preloads an edge 115 of the motor housing 114 and an edge 117 of the pump housing 116 toward one another. The edge 115 of the motor housing 114 is, as viewed from the stator 121, arranged on the side facing toward the pump housing 116. A rotor 122 is arranged in the pump stage 111 and in that portion 124 of the motor housing 114 that is made of plastic.

In the case of the fuel pumps 5, 105 from FIGS. 1 to 5, the pump stages 11, 111 are formed as screw pumps. Two screw spindles of the pump stages 11, 111 form, in conjunction with the pump housing 16, 116, delivery chambers which move from a suction side to a pressure side of the pump stage 11, 111 owing to the rotation of the screw spindles. In an alternative embodiment, which is not illustrated, the pump stages may also be in the form of a side-channel or a peripheral pump.

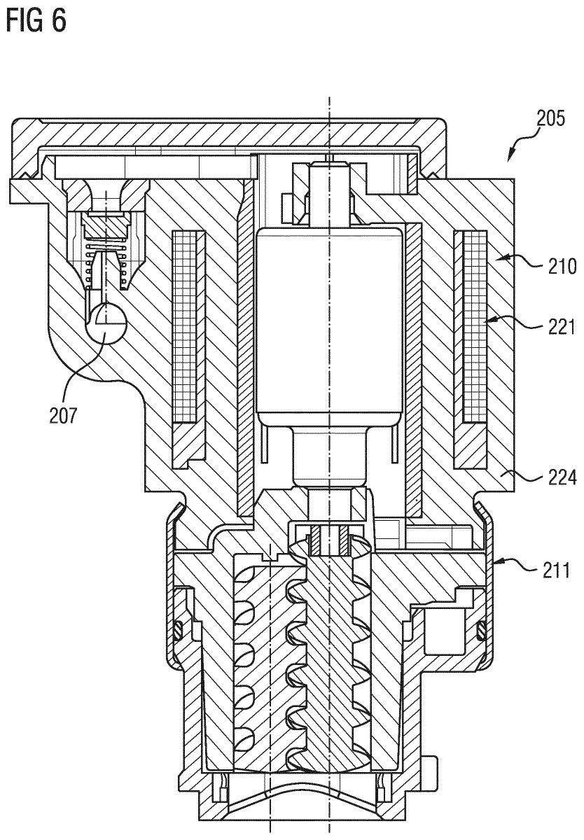

FIG. 6 shows a longitudinal section through a further embodiment of a fuel pump 205. This differs from that in FIG. 2 in that a connector piece 207 for the feed line 8 illustrated in FIG. 1 is formed as a single piece with a portion 224, which holds a stator 221, of an electric motor 210.

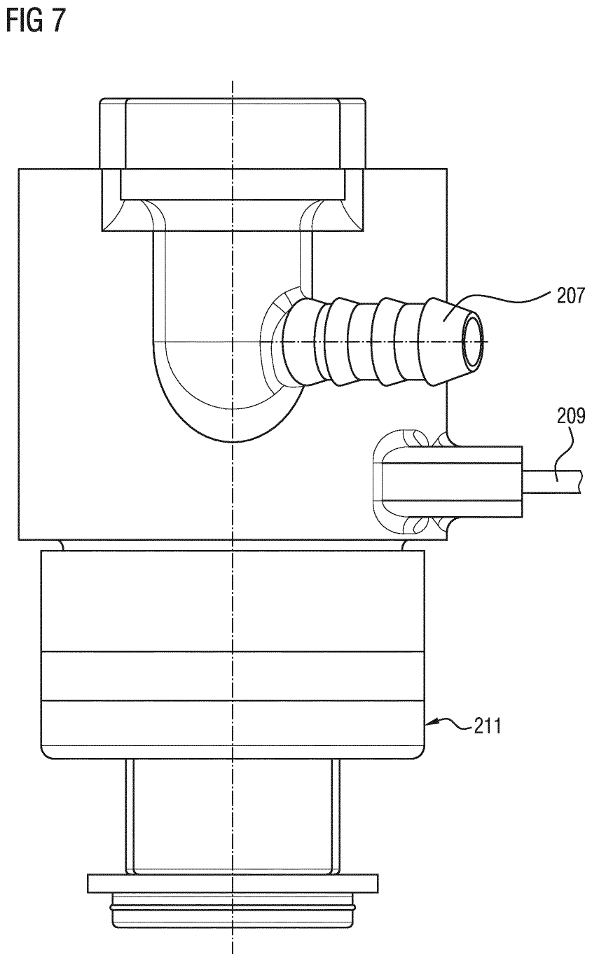

FIG. 7 shows a side view of the fuel pump 205 from FIG. 6. It can be seen in this view that connection lines 209 leading to the stator 221 are arranged closer than the connector piece 207 to a pump stage 211.

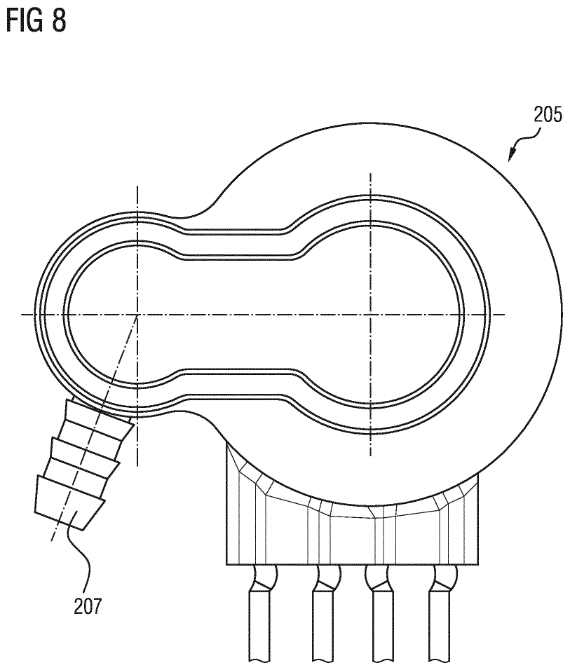

FIG. 8 shows, in a plan view of the fuel pump 205 from FIG. 6, that the connector piece 207 is angled in relation to axes of symmetry of the fuel pump 205. The embodiment of the fuel pump 205 as per FIGS. 6 to 8 is otherwise constructed substantially similarly to that from FIGS. 1 to 3.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-13. (canceled)

14. A fuel pump (5, 105, 205) comprises:
an electric motor (10, 110, 210), the electric motor having a rotor (22, 222) and a stator (21, 121, 221) that surrounds the rotor (22, 222);
a pump stage (11, 111, 211);
a motor housing (14, 114) of the electric motor (10, 110, 210), the motor housing having a motor housing edge (15, 17, 115, 117);
a pump housing (16, 116) of the pump stage (11, 111, 211), the pump housing having a pump housing edge (16, 116); and
a sheet-metal casing (18, 118) engaging behind the motor housing edge (15, 17, 115, 117) and behind the pump housing edge (16, 116),
wherein the motor housing (14, 114) is configured and arranged to hold the stator (21, 121, 221) of the electric motor (10, 110, 210), the motor housing (14, 114) having a portion (24, 124, 224) made of plastic that holds the stator (21, 121, 221), and wherein, as viewed from the stator (21, 121, 221), the motor housing edge (15, 115) for the sheet-metal casing (18) is arranged on a side facing toward the pump housing (16, 116).

15. The fuel pump as claimed in claim 14, wherein a height of the sheet-metal casing (18, 118) is at most 50% of a sum of heights of the pump housing (16, 116) and of the motor housing (14, 114).

16. The fuel pump as claimed in claim 15, wherein the stator (21, 121, 221) comprises connection contacts (29, 129) that are arranged so as to be sealingly enclosed by the plastic portion (24, 124, 224) of the motor housing (14, 114).

17. The fuel pump as claimed in claim 16, further comprising connection lines (9, 109, 209) leading to the electric motor (10, 110) that are led radially into the plastic portion (24, 124, 224) of the motor housing (14, 114).

18. The fuel pump as claimed in claim 17, wherein the plastic portion (24, 124, 224) of the motor housing (14, 114) has a connector piece (7, 107, 207) for a fuel line (8, 108).

19. The fuel pump as claimed in claim 18, wherein the connector piece (7, 107, 207) is led away from the motor housing radially.

20. The fuel pump as claimed in claim 19, wherein the connector piece (7, 207) is arranged at an axial height of the stator (21, 221).

21. The fuel pump as claimed in claim 20, further comprising a cover (28, 128), that leads to the connector piece (7, 107, 207) of a fuel-conducting channel (13, 113), and that is sealed off on the plastic portion (24, 124, 224) of the motor housing (14, 114).

22. The fuel pump as claimed in claim 21, wherein a portion of the fuel-conducting channel (13) is led, parallel to an axis of the rotor (22), from the end averted from the pump housing (16) into the motor housing (14).

23. The fuel pump as claimed in claim 22, wherein the rotor (22, 122) of the electric motor (10, 110) is mounted with a first end on the pump housing (16, 116) and with a second end in the plastic portion (24, 124, 224) of the motor housing (14, 114).

24. The fuel pump as claimed in claim 23, wherein the plastic portion (24, 124, 224) of the motor housing (14, 114) that holds the stator (21, 121, 221) has an open side, facing the pump housing (16, 116), into which the rotor (22, 122) is insertable.

25. The fuel pump as claimed in claim 24, wherein the plastic portion (24, 124, 224) of the motor housing (14, 114) has support arms (26) configured and arranged to support a bearing arrangement (25) of the rotor (22, 122), and wherein the fuel-conducting channel (13, 113) leads through between the support arms (26).

26. The fuel pump as claimed in claim 25, further comprising a sealing ring (30, 130) with radial sealing action arranged between the pump housing (16, 116) and the sheet-metal casing (18, 118).
